(19) United States
(12) Patent Application Publication
(10) Pub. No.: US 2017/0086625 A1
(43) Pub. Date: Mar. 30, 2017

(54) DISPENSER DEVICE INCORPORATING HAND HYGIENE INSTRUCTIONS

(71) Applicant: Betco Corporation, Bowling Green, OH (US)

(72) Inventors: John E. Mitchell, Temperance, MI (US); Krysten M. Comperchio, Sylvania, OH (US)

(73) Assignee: Betco Corporation, Bowling Green, OH (US)

(21) Appl. No.: 15/251,622

(22) Filed: Aug. 30, 2016

Related U.S. Application Data
(60) Provisional application No. 62/233,583, filed on Sep. 28, 2015.

(51) Int. Cl. A47K 5/12; G09B 5/02; G09B 19/00

(52) U.S. Cl. CPC A47K 5/1211; G09B 19/0076; G09B 5/02

(57) ABSTRACT

A dispenser device is provided. The dispenser device includes a reservoir configured to store dispensing material and release the dispensing material upon demand. A pump/valve mechanism is configured for fluid connection with the reservoir. An output structure is configured for fluid connection with the pump/valve mechanism. A controller is configured to generate and send dispensing signals to the pump/valve mechanism to release the dispensing material. A display device is in communication with the controller. The display device is configured to illustrate techniques for proper hand hygiene.

### RELATED APPLICATIONS

This application claims priority from pending U.S. Provisional Patent Application No. 62/233,583, filed Sep. 28, 2015, the disclosure of which is incorporated herein by reference in its entirety.

### BACKGROUND

Dispensing devices are used in many facilities and industries for storing and dispensing all forms of liquids, solids and powders. One non-limiting example of a dispensing device is a device for dispensing hand cleaning liquids. The complexity of dispensing devices can range from simple enclosures having manual dispensing mechanisms to cutting edge technology enclosures with sensors configured to sense the presence of an object and dispense a liquid, solid and/or powder in response to the sensed object.

While the, technology related to dispensing devices continues to advance, the effectiveness of the dispensed material to clean remains dependent upon the user. As a specific example, dispensing devices can be configured to dispense hand cleaning liquids, solids and/or powders. However, the effectiveness of the hand cleaning materials can be dependent upon the user's technique of washing his/her hands.

The concern over the proper technique of washing one's hands is acknowledged by the U.S. Center for Disease Control and Prevention (hereafter “CDC”), who notes that hand hygiene is one of the most important ways to prevent the spread of infections, In this light, the CDC has developed various instructional materials (e.g. posters and videos) that provide guidance as to approved hand washing techniques.

It would be advantageous if dispensing devices could be improved to guide users with approved hand hygiene techniques.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the programmable locking dispenser.

The above objects as well as other objects not specifically enumerated are achieved by a dispenser device. The dispenser device includes a reservoir configured to store dispensing material and release the dispensing material upon demand. A pump/valve mechanism is configured for fluid connection with the reservoir. An output structure is configured for fluid connection with the pump/valve mechanism. A controller is configured to generate and send dispensing signals to the pump/valve mechanism to release the dispensing material. A display device is in communication with the controller. The display device is configured to illustrate techniques for proper hand hygiene.

There is also provided a method of operating a dispenser device. The method includes the steps of storing dispensing material in a reservoir, generating and sending dispensing signals to a pump/valve mechanism to release the dispensing material, dispensing the dispensing material upon receipt of the dispensing signals and displaying techniques for proper hand hygiene on a display device simultaneous with the dispensing of the dispensing material.

There is also provided a dispenser device. The dispenser device includes a reservoir configured to store dispensing material and release the dispensing material upon demand. A pump/valve mechanism is configured for fluid connection with the reservoir. An output structure is configured for fluid connection with the pump/valve mechanism. An activation device is configured to generate and send dispensing signals to the pump/valve mechanism to release the dispensing material and a display device is in communication with the activation device, the display device configured to illustrate, techniques for proper hand hygiene.

Various objects and advantages of the programmable locking dispenser will become apparent to those skilled in the art from the following detailed description, when read in light of the accompanying drawings.

### BRIEF DESCRIPTION OF THE DRAWINGS

FIG. 1 is a perspective view of a dispenser device.

FIG. 2 is a front view, in elevation, of the dispenser device of FIG. 1 shown with a dispenser cover rotated to an open orientation.

FIG. 3a is a front view, in elevation, of a display device of the dispenser device of FIG. 1.

FIG. 3b is right side view, in elevation, of the display device of FIG. 3a.

FIG. 3c is a front view, in elevation, of the display device of FIG. 3a.

FIG. 4a is a schematic view of the display device of FIG. 3a illustrating a first step of an approved hand hygiene technique.

FIG. 4b is a schematic view of the display device of FIG. 3a illustrating a second step of an approved hand hygiene technique.

FIG. 4c is a schematic view of the display device of FIG. 3a illustrating a third step of an approved hand hygiene technique.

FIG. 4d is a schematic view of the display device of FIG. 3a illustrating a fourth step of an approved hand hygiene technique.

FIG. 4e is a schematic view of the display device of FIG. 3a illustrating a fifth step of an approved hand hygiene technique.

FIG. 4f is a schematic view of the display device of FIG. 3a illustrating a final step of an approved hand hygiene technique.

FIG. 5a is a front view of the display device of FIG. 3a illustrating a plurality of quadrants.

FIG. 5b is a front view of the display device of FIG. 5a illustrating rotation of hand hygiene techniques from quadrant to quadrant.

FIG. 6a is a schematic view of the display device of FIG. 3a illustrating a first step of a second approved hand hygiene technique.

FIG. 6b is a schematic view of the display device of FIG. 3a illustrating a final step of a second approved hand hygiene technique.

FIG. 7a is a front perspective view of a dispenser device having manual activation, shown in a non-activated arrangement.

FIG. 7h is a front perspective view of the dispenser device of FIG. 7a, shown in an activated arrangement.

### DETAILED DESCRIPTION

The dispenser device incorporating hand hygiene instructions will now be described with occasional reference to the specific embodiments of the dispenser device. The dispenser device incorporating hand hygiene instructions may, however, be embodied in different forms and should not be construed as limited to the embodiments set forth herein. Rather, these embodiments are provided so that this disclosure will be thorough and complete, and will fully convey the scope of the dispenser device incorporating hand hygiene instructions to those skilled in the art.

Unless otherwise defined, all technical and scientific terms used herein have the same meaning as commonly understood by one of ordinary skill in the art to which the dispenser incorporating hand hygiene instructions belongs. The terminology used in the description of the dispenser incorporating hand hygiene instructions herein is for describing particular embodiments only and is not intended to be limiting of the dispenser device incorporating hand hygiene instructions. As used in the description of the dispenser device incorporating hand hygiene instructions and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present dispenser incorporating hand hygiene instructions. Notwithstanding that the numerical ranges and parameters setting forth the broad scope of the dispenser incorporating hand hygiene instructions are approximations, the numerical values set forth in the specific examples are reported as precisely as possible. Any numerical values, however, inherently contain certain errors necessarily resulting from error found in their respective measurements.

In accordance with illustrated embodiments, the description and figures disclose a dispenser device (hereafter “dispenser”) incorporating and displaying approved hand hygiene instructions and a method of using the dispenser. Generally, the dispenser includes a visual display device configured to show approved techniques, in a step-by-step format, for proper hand hygiene. The techniques can include the non-limiting examples of approved hand washing techniques and hand sanitizing techniques. The term “dispenser”, as used herein, is defined to mean any container for storing and dispensing a material.

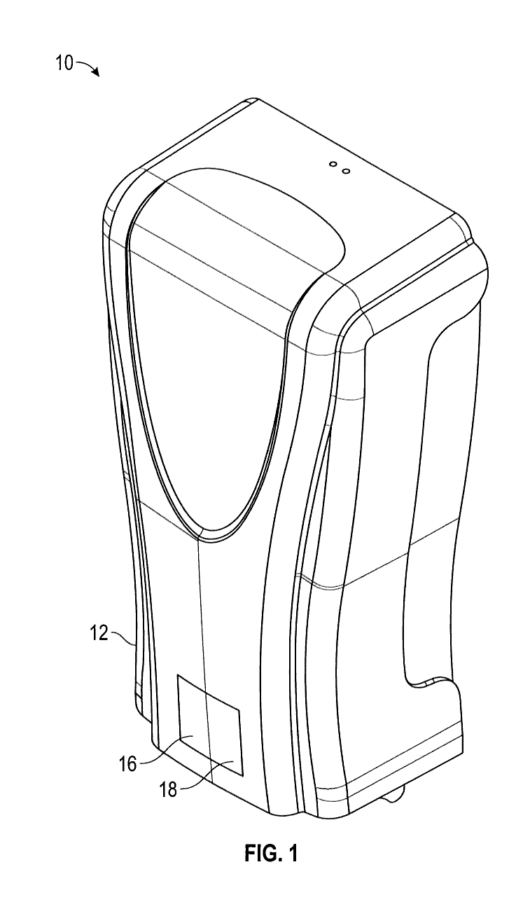

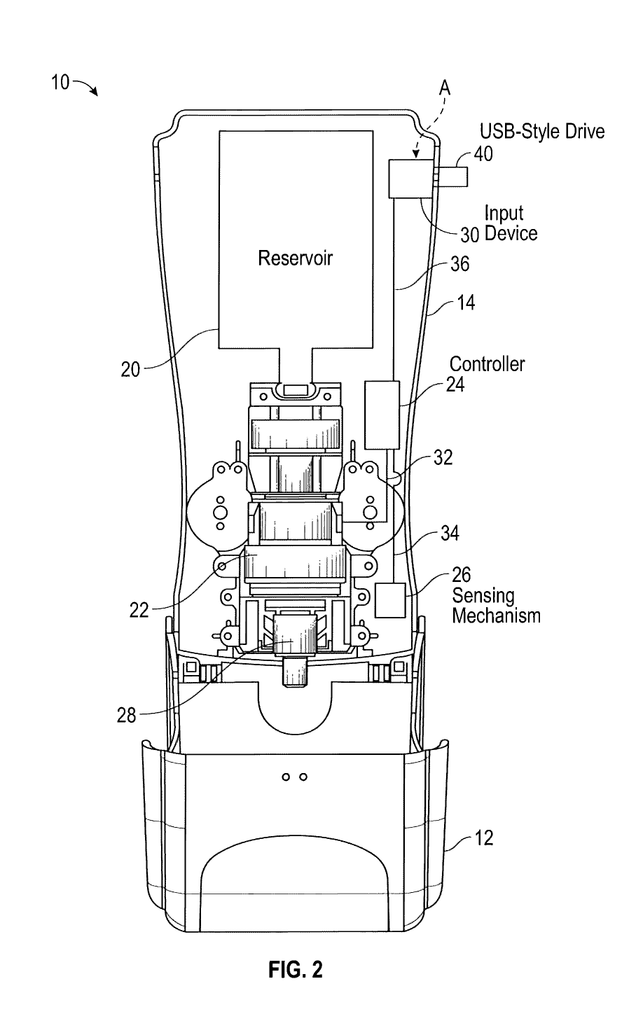

Referring now to FIGS. 1 and 2, one non-limiting embodiment of a dispenser is shown schematically at 10. The dispenser 10 is configured to store and dispense dispensable materials, such as for example liquids, solids and powders. The dispenser 10 includes a dispenser cover 12, configured to enclose a dispenser base 14. The dispenser cover 12 is rotatable from a dosed orientation as shown in FIG. 1 to an open orientation as shown in FIG. 2. In the closed orientation, the dispenser cover 12 is configured to enclose the dispenser base 14 and various components mounted to the dispenser base 14. In the open orientation, the dispenser base 14 and the various components mounted to the dispenser base 14 are visually exposed.

Referring now to FIG. 1, the dispenser cover 12 includes an aperture 16 configured to allow exposure of a display device 18. The display device 18 will be discussed in more detail below. The dispenser cover 12 can have any desired shape, contours, size or configuration and can be made from any desired material or materials sufficient to cover the dispenser base 14 and the components mounted to the dispenser base 14. In certain embodiments, the dispenser cover 12 can be configured to support various components and assemblies (not shown).

Referring now to FIG. 2, the dispenser 10 also includes a container or reservoir, shown schematically at 20, a pump/valve mechanism 22, a controller shown schematically at 24, a sensing mechanism shown schematically at 26, an output structure 28 and an input device schematically at 30.

Referring again to FIG. 2, in certain embodiments, the dispenser 10 can include an internal power supply (not shown) and in other embodiments, the dispenser 10 can be powered from sources external to the dispenser 10. The internal and external power sources are not shown in FIG. 2 for purposes of clarity.

Referring again to FIG. 2, the reservoir 20 is configured to store dispensing material (not shown) and release the dispensing material upon demand. In certain embodiments, the reservoir 20 can be a pouch or bag. Alternatively, the reservoir 20 can be any structure, such as for example a canister or collapsing semi-rigid bottles, configured to store and release dispensing material. The dispensing material can be any desired material and can have any desired form. Non-limiting examples of dispensing material forms include liquids, solids, powders and aerosols. Non-limiting examples of dispensing materials include skin cleaners, hair washes, skin lotions, detergents, softeners, bleaches, sanitizers, degreasers, finishes, strippers, glass cleaners, disinfectants and the like.

Referring again to FIG. 2, the pump/valve mechanism 22 fluidly connects the reservoir 20 with the outlet structure 28. The pump/valve mechanism 22 is electrically connected to the controller 24 via connector 32. In certain instances, the pump/valve mechanism 22 receives one or more electrical activation signals from the controller 24 and releases a metered amount of dispensing material from the reservoir 20 to the outlet structure 28. Pump/valve mechanisms 22 are known in the art. Any desired pump/valve mechanism 22, sufficient to receive electrical activation signals from the controller 24 and release a metered amount of dispensing material from the reservoir 20 to the outlet structure 28, can be used.

Referring again to FIG. 2, the outlet structure 28 is connected to the pump/valve mechanism 22 and includes an aperture (not shown), through which the dispensing material exits the dispenser 10. The outlet structure 28 can have any desired shape, size and configuration sufficient to allow dispensing material to flow from the pump/valve mechanism 22 and exit the dispenser 10.

Referring again to FIG. 2, the controller 24 is in electrical communication with the sensing mechanism 26 via connector 34. The controller 24 is also in electrical communication with the display device 18 via another connector (not shown). The controller 24 is configured for several functions. First, the controller 24 is configured to receive signals from the input device 30 via electrical connector 36. The signals received from the input device 30 can include programming code for enabling operation of the dispenser 10 or disabling operation of the dispenser 10. The programming code can also include operational instructions for control of various dispensing components. Second, the controller 24 is configured to store the programming code for subsequent use. Storage of the programming code is accomplished by a memory (not shown), contained within the controller 24. The memory can have any desired structure, sufficient to store the programming code for subsequent use. Third, the controller 24 is configured to receive activation signals from the sensing mechanism 26 or other signal generators, such as the non-limiting example of a manually operated actuator device (not shown). Fourth, upon receiving the activation signals, the controller 24 is configured to compare the activation signal with the programming codes, thereby enabling or disabling operation of the dispenser 10. The controller 24 is also configured to generate and send dispensing signals to the pump/valve mechanism 22 upon receipt of a proper activation signal with the dispenser 10. Finally, as the pump/valve mechanism 22 is releasing the dispensing material, the controller 24 can be configured to simultaneously generate and send signals to the display device 18. As will be discussed in more detail below, the display device 18 can, in turn, display approved user messages, such as for example, hand washing instructions.

Referring again to the embodiment illustrated in FIG. 2, the controller 24 is a microprocessor-based device sufficient to provide the functions discussed above. However, in other embodiments the controller 24 can be any device sufficient to provide the functions discussed above. Optionally, the controller 24 can be equipped with visual and/or audio displays configured to indicate the condition or status of various modes or operations of the controller 24 and/or dispenser 10. In one example, the controller 24 can include status lights indicating an unlocked or locked operating mode. Examples of suitable visual and/or audio displays include display screens, status lights, beeps and buzzers.

Referring again to FIG. 2, the sensing mechanism 26 is configured to generate activation signals upon the occurrence of an activating event. Non-limiting examples of activation events can include sensing the presence of a person or object. The generated activation signals are conveyed to the controller 24 via connector 34. Sensing mechanisms are known in the art and any desired sensing mechanism, sufficient to generate activation signals upon the occurrence of an activating event, can be used.

Referring again to FIG. 2, the input device 30 can be configured for several functions. In certain instances, the input device 30 can be configured to wirelessly receive programming signals from devices located remotely from the dispenser 10, as indicated by schematic direction arrow A. Non-limiting examples of remote devices include wireless satellite communications, remote computer/internet-based devices and remote handheld electronic devices, such as for example smartphones and tablets. Upon receipt of the programming signals, the input device 30 is configured to convey the programming signals to the controller 24. In other instances, the input device 30 can be configured to generate programming signals and convey the generated programming signals to the controller 24. In these instances, the programming signals can be generated by structures such as for example, keypads, numeric pads, touch screens and the like. In still other instances, the input device 30 can be configured for physical connection to other structures and devices containing programming signals. In one non-limiting example, the input device 30 is configured to communicate with a mobile storage device having a USB-style structure, shown schematically at 40. In another example, the input device 30 can be configured for physical connection to handheld electronic devices, such as for example smartphones and tablets. The mobile storage device 40 can include programming signals that can be received by the input device 30 and subsequently conveyed to the controller 24 by the input device 30. The mobile storage device 40 advantageously provides ease of use and cost-reducing possibilities.

While the input device 30 shown in FIG. 2 is illustrated as a distinct structure spaced apart from the controller 24, it is within the contemplation of the dispenser 10 that the input device 30 can be integral to the controller 24.

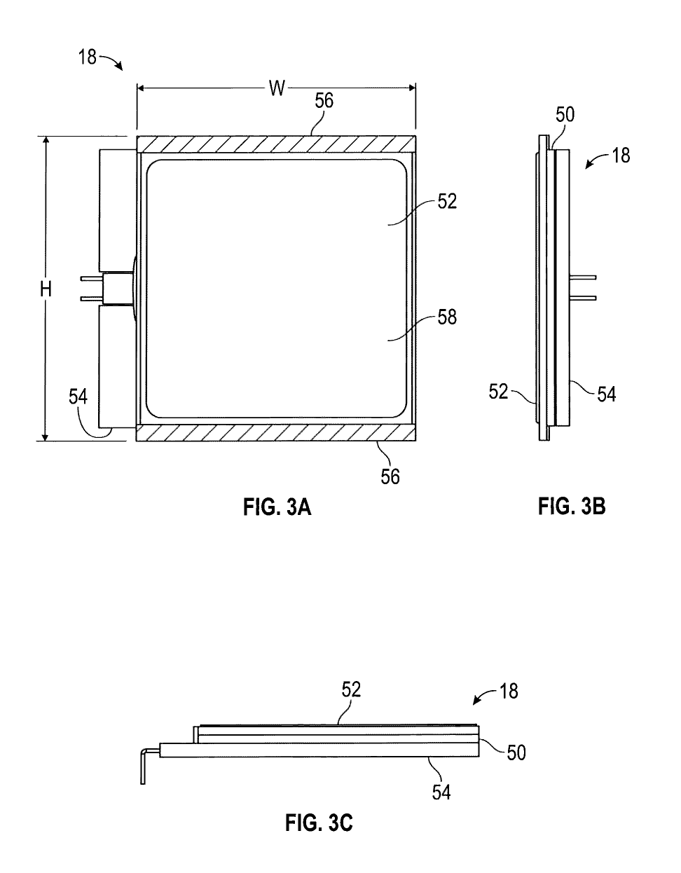

Referring again to FIG. 1, as discussed above, as the pump/valve mechanism 22 is releasing the dispensing material, the controller 24 simultaneously generates and sends signals to the display device 18. The signals sent to the display device 18 cause the display 18 to show approved techniques, in a step-by-step format, for proper hand hygiene. One non-limiting example of a display device 18 is illustrated in FIGS. 3a-3c. The display device 18 includes a base 50, configured to support a screen 52 on one side of the base 50 and a backlight structure 54 on the other side of the base 50.

Referring again to embodiment illustrated in FIGS. 3a-3c, the screen 52 has the form of a liquid crystal display (commonly referred to as LCD) and illustrates images in a monochrome format. The LCD-type of screen 52 and the monochrome format advantageously allows operation with low power requirements. Accordingly, maintenance requirements of a power source are minimized. While the embodiment of the screen 52 shown in FIGS. 3a-3c is described as an LCD-type of display, it should be appreciated that other display devices, sufficient to display approved hand hygiene techniques, in a step-by-step format, for proper hand hygiene with low power requirements can be used, such as the non-limiting examples of eInk screens or siPix screens. It should also be appreciated that in other embodiments, color formats can be used in lieu of monochrome formats.

Referring again to FIGS. 3a-3c, the backlight structure 54 is configured to provide illumination to produce visible images on the screen 52. Backlight structures 54 are known in the art and any backlight structure 54, suitable to produce visible images on the screen 52 can be used.

Referring again to FIGS. 3a-3c, the display device 18 further includes a plurality of electrical contacts in the form of connector strips 56. The connector strips 56 are configured to provide an interface with electrical connectors originating with the controller 24. Connector strips 56 are known in the art and any connector strip 56, suitable to provide an interface with electrical connectors originating with the controller 24 can be used.

Referring now to FIG. 3a, an exposed surface 58 of the display device 18 has a compact area sufficient to display approved hand hygiene techniques. The exposed surface 58 of the display device 18 has a width W and a height H. In the illustrated embodiment, the width W and the height H are both 1.5 inches. However, in other embodiments, the width W and the height H can be more or less than 1.5 inches, sufficient to display approved hand hygiene techniques. In still other embodiments, the width W can be different from the height H, sufficient to display approved hand hygiene techniques.

As discussed above, as the pump/valve mechanism 22 releases the dispensing material, the controller 24 simultaneously generates and sends signals to the display device 18. The display device 18, in turn, displays approved techniques, in a step-by-step format, for proper hand hygiene. The displayed techniques can have different forms and can address different hygiene subject matter.

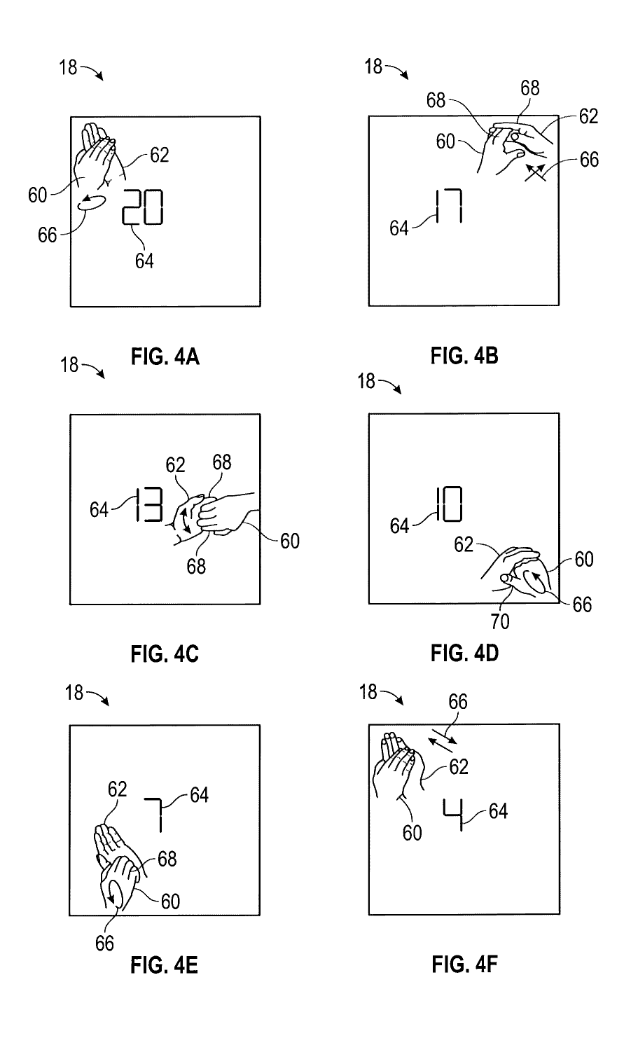

Referring now to FIGS. 4a-4f, a first non-limiting example of a hand hygiene sequence is illustrated. In this example, an approved step-by-step technique for hand washing is illustrated in sequential screen displays by the display device 18. Referring first to FIG. 4a, the user's right hand is identified by reference character 50 and the user's left hand is identified by reference character 52. The display 18 includes a time element 64, configured to display the amount of time remaining in the hand hygiene sequence, in seconds. The display 18 further includes a motion indicator 66. The motion indicator 66 is configured to provide a visual indication of the type and direction of the movement of the user's right and left hands 60, 62. As shown by FIG. 4a, the user is directed to rub right and left hands 60, 62 together, with the dispensed material, in a circular motion 66, with the right and left hands 60, 62 positioned in a palm to palm orientation.

Referring now to FIG. 4b in a next sequential screen display at time 17 seconds, as indicated by time element 64, the user is instructed to rub right and left hands 60, 62 together, in a palm to palm orientation. As indicated by the motion indicator 66, the palm to palm orientation includes arranging fingers 68 of the right and left hands 60, 62 in an interlaced manner.

Referring now to FIG. 4c in a next sequential screen display at time 13 seconds, as indicated by time element 64, the user is instructed to rub right and left hands 60, 62 together with the backs of the fingers 68 in contact with the opposing palm and the fingers 68 arranged in a nested manner. As indicated by the motion indicator 66, the right and left hands 60, 62 are rubbed together in a top-to-bottom motion manner.

Referring now to FIG. 4d in a next sequential screen display at time 10 seconds, as indicated by time element 64, the user is instructed to rub right and left hands 60, 62 together with a left thumb (not shown) clasped in the right hand 60 and a right thumb 70 pressed against the left hand 62. As indicated by the motion indicator 66, the right and left hands 60, 62 are rubbed together in a circular motion.

Referring now to FIG. 4e in a next sequential screen display at time 7 seconds, as indicated by time element 64, the user is instructed to rub right and left hands 60, 62 together with the fingers 68 of the right hand 60 in folded or clasped orientation and pressed against the palm of the left hand 62. As indicated by the motion indicator 66, the right and left hands 60, 62 are rubbed together in a circular motion.

Referring now to FIG. 4e in a final sequential screen display at time 4 seconds, as indicated by time element 64, the user is instructed to rub right and left hands 60, 62 together with the palm of the right hand 60 seated against the palm of the left hand 62. As indicated by the motion indicator 66, the right and left hands 60, 62 are rubbed together a back and forth motion.

Referring again to the embodiment illustrated in FIGS. 4a-4f, total duration of the illustrated sequence is approximately 20.0 seconds, with each of the steps appearing on the display device 18 for a duration of about 3.0-4.0 seconds. However, it should be appreciated that in other embodiments, the total duration of the illustrated. sequence can be less than or more than about 20.0 seconds and each of the steps can appear on the display device 18 for a duration of less than about 3.0 seconds or more than about 4.0 seconds.

Referring again to the embodiment shown in FIGS. 4a-4f, the illustrated hand hygiene sequence is configured to meets the hand hygiene standards as established by the U.S. Center for Disease Control and Prevention (hereafter “CDC”). However, it should be appreciated that the illustrated hand hygiene sequence can be any desired sequence sufficient to meet any desired hand hygiene standards.

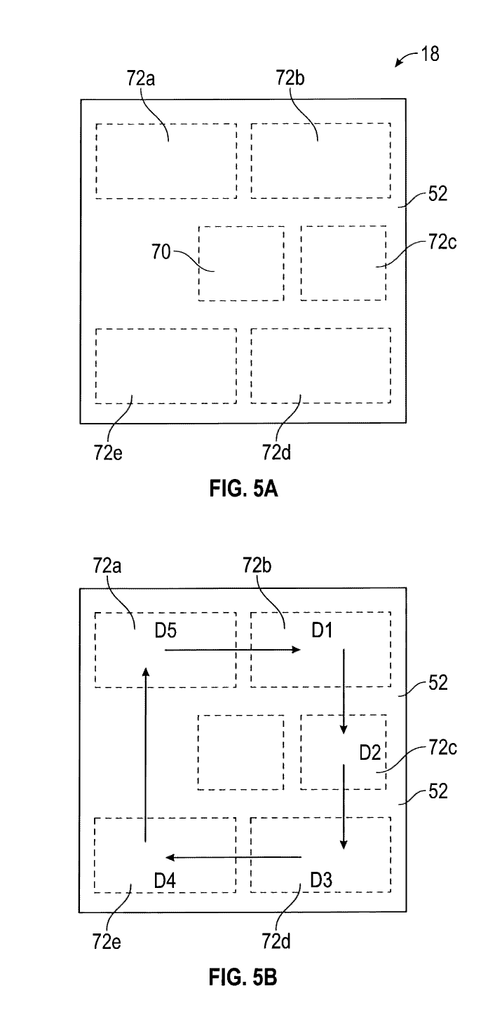

Referring now to FIG. 5a, the screen 52 of the display device 18 is illustrated. The screen 52 is arranged with a plurality of quadrants 70, 72a-72e. Quadrant 70 is generally centered on the screen 52 and is configured to display the time element 64. Quadrant 72a is positioned in an upper left location on the screen 52 and is configured to display the initial step of the illustrated sequence shown in FIG. 4a. Quadrant 72b is positioned in an upper right location on the screen 52 and is configured to display the second step of the illustrated sequence shown in FIG. 4b. Quadrant 72c is positioned in a middle right location on the screen 52 and is configured to display the third step of the illustrated sequence shown in FIG. 4c. Quadrant 72d is positioned in a lower right location on the screen 52 and is configured. to display the fourth step of the illustrated sequence shown in FIG. 4d. Quadrant 72e is positioned in a lower left location on the screen 52 and is configured to display the fifth step of the illustrated sequence shown in FIG. 4e. The final step of the illustrated sequence is displayed in quadrant 72a, as shown in FIG. 4f.

Referring now to FIG. 5b, the quadrants 72a-72e are illustrated. In this arrangement of quadrants, the sequence of hand hygiene instructions form a circular pattern starting and ending with quadrant 72a. For example, the initial step of the illustrated sequence shown in quadrant 72a is followed by the second step of the illustrated sequence shown in quadrant 72b, as indicated by direction arrow D1. The second step of the illustrated sequence shown in quadrant 72b is followed by the third step of the illustrated sequence shown in quadrant 72c, as indicated by direction arrow 132. Subsequent sequence steps follow as indicated by direction arrows D3-D5, thereby forming a generally circular path of sequence steps. Without being held to the theory, it is believed the arrangement of the sequential steps in the generally circular pattern better maintains the attention of the user. However, it is within the contemplation of the invention, that the screen 52 of the display device 18 can be arranged in other patterns and the sequential steps of the hand hygiene instructions can follow other desired paths.

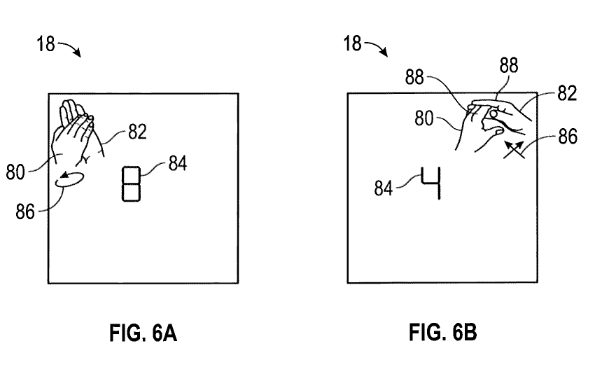

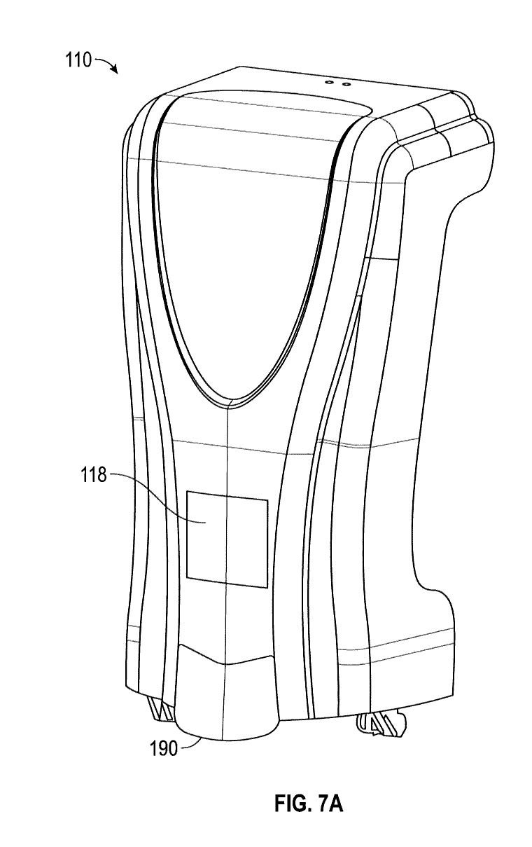

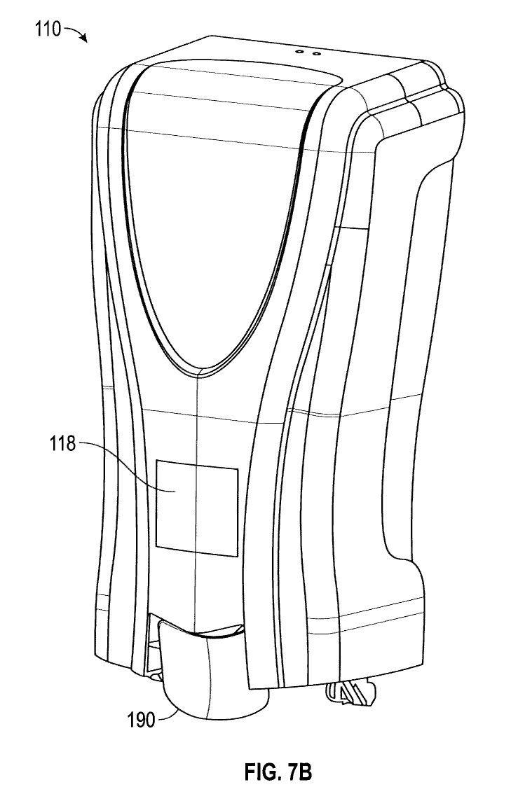

Referring now to FIGS. 6a and 6b, a second non-limiting example of a hand hygiene technique is illustrated. In this example, an approved technique for hand sanitizing is presented in a step-by-step format. Referring first to FIG. 6a, the user's right hand is identified by reference character 80 and the user's left hand is identified by reference character 82. The display 18 includes a time element 84, configured to display the amount of time remaining in the hand hygiene sequence, in seconds. The display 18 further includes a motion indicator 86. As shown by FIG. 6a, the user is directed to rub right and left hands 80, 82 together, with the dispensed sanitizing material, in a circular motion 86, with the right and left hands 60, 62 positioned in a palm to palm orientation.

Referring now to FIG. 6b in a final sequential screen display at time 4 seconds, as indicated by time element 84, the user is instructed to rub right and left hands 80, 82 together, in a palm to palm orientation. As indicated by the motion indicator 86, the palm to palm orientation includes arranging fingers 88 of the right and left hands 80, 82 in an interlaced manner.

Referring again to FIGS. 6a-6b, total duration of the sanitizing presentation is approximately 8.0 seconds with each of the steps appearing on the display device for a duration of about 3.0-4.0 seconds. However, it should be appreciated that in other presentations, the total duration can be less than or more than about 8.0 and each of the steps can appear on the display device for a duration of less than about 3.0 seconds or more than about 4.0 seconds.

It should be understood that the examples illustrated in FIGS. 4a-4f and 6a-6b are non-limiting. Accordingly, it is contemplated that the dispenser 10 can be configured to present other hand hygiene instructions. It is further contemplated that the dispenser 10 can be configured to present other subject matter, such as for example safety instructions.

While the embodiment of the dispenser device 10 described above and shown in FIGS. 1 and 2 provides for “touch-free dispensing”, that is, the sensing mechanism 26 and the controller 24 are configured to automatically generate dispensing signals upon the occurrence of a non-contact activating event, it is within the contemplation of the invention that the activating event can be contact induced. Referring now to FIGS. 7a and 7b, a second embodiment of a dispenser device is shown generally at 110. In the illustrated embodiment, the dispenser device 110 is the same as, or similar to the dispenser device 10 described above and shown in FIGS. 1 and 2, with the exception that the dispenser device 110 includes a contact activation device 190. The contact activation device 190 is configured for connection with the pump/valve mechanism 22 and further configured for communication with the display device 18.

Referring now to FIG. 7a, the dispenser device 110 is shown in an “at rest” arrangement. That is, the contact activation device 190 has not been activated by contact. In this arrangement, the pump/valve mechanism 22 is not directed to dispense dispensing material and there is no communication with the display device 118 to display approved hand hygiene instructions.

Referring now to FIG. 7b, the dispenser device 110 is shown in an “activated” arrangement. That is, portions of the contact activation device 190 have been depressed by contact, thereby activating the dispenser device 110. In this arrangement, activation of the contact activation device 190 directs the pump/valve mechanism 22 to dispense dispensing material and simultaneously further directs the display device 118 to display approved hand hygiene instructions.

In the embodiment illustrated in FIGS. 7a and 7b, the contact activation device 190 has the form of a push lever or bar. However, in other embodiments, the contact activation device 190 can have other forms, including the non-limiting examples of switches, buttons, pull cords and the like.

The principle and mode of operation of the dispenser device incorporating hand hygiene instructions has been described in certain embodiments. However, it should be noted that the dispenser device incorporating hand hygiene instructions may be practiced otherwise than as specifically illustrated and described without departing from its scope.

What is claimed is:

1. A dispenser device comprising:
a reservoir configured to store dispensing material and release the dispensing material upon demand;
a pump/valve mechanism configured for fluid connection with the reservoir;
an output structure configured for fluid connection with the pump/valve mechanism;
a controller configured to generate and send dispensing signals to the pump/valve mechanism to release the dispensing material; and
a display device in communication with the controller, the display device configured to illustrate techniques for proper hand hygiene.

2. The dispenser device of claim 1, wherein the display device is configured to illustrate the proper hand hygiene techniques simultaneous with the dispensing of the dispensing material.

3. The dispenser device of claim 1, wherein the display device is a LCD type of display.

4. The dispenser device of claim 1, wherein the display device has a height of about 1.50 inches and a width of about 1.5 inches.

5. The dispenser device of claim 1, wherein the display device has a screen with a plurality of quadrants.

6. The dispenser device of claim 5, wherein the illustrated techniques for proper hand hygiene are successively rotated around different quadrants.

7. The dispenser device of claim 5, herein the display device further illustrates a time element.

8. The dispenser device of claim 7, wherein the time element is displayed in a centrally positioned quadrant.

9. The dispenser device of claim 1, wherein a dispenser cover is rotatably connected to a dispenser base.

10. A method of operating a dispenser device comprising the steps of:
storing dispensing material in a reservoir;
generating and sending dispensing signals to a pump/valve mechanism to release the dispensing material;
dispensing the dispensing material upon receipt of the dispensing signals; and
displaying techniques for proper hand hygiene on a display device simultaneous with the dispensing of the dispensing material.

11. The method of claim 10, wherein the display device is a LCD type of display.

12. The method of claim 10, wherein the display device has a height of about 1.50 inches and a width of about 1.5 inches.

13. The method of claim 10, wherein the display device has a screen with a plurality of quadrants.

14. The method of claim 13, including the step of rotating the illustrated techniques for proper hand hygiene around different quadrants.

15. The method of claim 10, including the step of displaying a time element,

16. The method of claim 15, wherein the time element is displayed in a centrally positioned quadrant.

17. The method of claim 10, wherein the techniques for proper hand hygiene include hand sanitizing techniques.

18. A dispenser device comprising:
a reservoir configured to store dispensing material and release the dispensing material upon demand;
a pump/valve mechanism configured for fluid connection with the reservoir;
an output structure configured for fluid connection with the pump/valve mechanism;
an activation device configured to generate and send dispensing signals to the pump/valve mechanism to release the dispensing material; and
a display device in communication with the activation device, the display device configured to illustrate techniques for proper hand hygiene.

19. The dispenser device of claim 18, wherein the activation device is activated by contact.

20. The dispenser device of claim 18, wherein the activation device has the form of a push bar.
